(19) United States
(12) Patent Application Publication
(10) Pub. No.: US 2012/0106330 A1
(43) Pub. Date: May 3, 2012

(54) Low Delay Lossless Packet Selector

(76) Inventor: Niall Thomas Davidson, Hamilton (GB)

(21) Appl. No.: 13/222,343

(22) Filed: Aug. 31, 2011

Related U.S. Application Data
(60) Provisional application No. 61/408,619, filed on Oct. 31, 2010.

(51) Int. Cl. H04L 12/26

(52) U.S. Cl. 370/230; 370/235

(57) ABSTRACT

A method and apparatus for selecting packets from a plurality of packets containing one or more copies of data, the method and apparatus selecting packets such that a single copy of the data can be selected. The method using identifying information contained within the packets to select only packets which contain unselected data, and using a searchable means to maintain a memory of unselected packets. Packets are selected as they become selectable and no unnecessary delay or data loss is suffered if some of the packets suffer loss. The method is suitable for selecting packets on a receiving device which receives duplicate copies of data packets from physically diverse paths, for example, as used by the FIX protocol. The method both hardening data against loss and delay and enabling improvements in average delay and jitter when used on a receiving device to select packets.

### CROSS-REFERENCES

This application claims the benefit of U.S. Provisional Application No. 61/408,619, filed Oct. 31, 2010 which is herein incorporated by reference in its entirety.

### BACKGROUND

Computer networks have become a foundation of the modern world and the data that they carry supports the global economy. In order to harden and improve the reliability of communications traveling over computer networks the use of multiple paths and multiple copies of traffic to transfer mission critical information is employed.

However some techniques used to select the duplicated traffic for reconstruction can cause unnecessary delay and can in some scenarios decrease the performance and robustness of the communications.

U.S. Pat. No. 7,099,327, Nagarajan et al., uses a technique to select packets which relies on the sequence number of a received signaling packet being larger or equal to an expected sequence number. Under some scenarios this technique can cause the loss of packets from the reconstructed packet stream when packets are dropped from only one duplicate packet stream.

U.S. Pat. No. 6,853,641, Lindhorst-Ko et al., uses a queue system to reconstruct the packet stream in the original order without packet loss and does not suffer loss if packets are dropped from a single path, however an unnecessary delay can be introduced to some packets.

Therefore an alternative technique which will select packets in such a way that will yield consistently low delays and protect against packet loss is desired.

### SUMMARY

The methods and apparatus disclosed are directed to satisfying this need. Selecting packets as soon as they are available for selection and maintaining a memory of packets which have not arrived when expected so that they can be recognized and selected when they do arrive. This allows packets to be selected as soon as they become available whilst not suffering data loss if packets are not lost from all duplicate packet streams.

The disclosed methods and apparatus may be used to select packets from a plurality of duplicate packet streams, selecting only those packets required to recover a single copy of a payload contained within the plurality of duplicate packet streams, this allows the payload to be protected against loss and delay.

The disclosed methods and apparatus finding uses where protecting traffic against packet loss and delay is desired and in-order delivery of packets is not critical, for example if VoIP packets from multiple calls are being trunked between Europe and North America using multiple submarine cables it is not useful to delay packets from one or more calls whilst waiting for a missing packet from one call. Another example of its use is in communicating financial information, if changes in stock price information is being delivered over multiple pathways it is only necessary that information for one particular stock is delivered in-order, it is not useful to delay unrelated stock information whilst waiting to deliver information for another stock in the original order.

The disclosed methods and apparatus can be used in combination with a plurality of duplicate packet streams to provide hardened communications which will render any terminal or temporary failure on a single pathway as a non-critical event, the selection technique providing instant failover operation which will be nearly imperceptible to the consumers of the protected packets.

The disclosed methods and apparatus may also be used to advantage in combination with a plurality of duplicate packet streams to improve upon the temporal characteristics of a communications link, improving average delay and jitter beyond that achievable by a traditional communications link. This advantage may be well suited for use with financial systems using existing protocols which use duplicate packet streams, for example the FIX protocol.

### DRAWINGS

These and other features, aspects, and advantages of the present invention will become better understood with regard to the following description, appended claims, and accompanying drawings where:

FIGS. 1, 2, 3 and 4 show examples of duplicate packet streams;

FIG. 5 shows an example of the order in which packets are selected by an implementation embodying principles of the invention under a specific scenario;

FIG. 6 shows an illustrative flowchart of an implementation embodying principles of the invention, and;

FIG. 7 shows a high level block diagram of an apparatus embodying principles of the invention.

### SPECIFICATION

It is intended that the following description and claims should be interpreted in accordance with Webster's Third New International Dictionary, Unabridged unless otherwise indicated.

A “L3 packet” or “layer 3 packet” as found in the following specification and claims is defined to refer to a “packet” as commonly used to describe a layer 3 protocol data unit, for example an IP or IPv6 packet.

A “packet” as found in the following specification and claims is defined as a generic term which should be interpreted as being a grouping, block or fragment of data. This definition of a packet includes, but is not limited to, frames, L3 packets, datagrams, segments and other related terminology such as protocol data units or service data units which describes packetized data. The term packet should not however be limited to include only data which is transmitted over a network and can be applied equally to refer to, for example, fields or records in a database.

A “packet stream” as found in the following specification and claims is defined as a succession of one or more packets. For example, frames being transported across an ethernet network link comprise a packet stream.

A “searchable means” as found in the following specification and claims is defined to be a structure in software or hardware that supports or enables at least two basic operations: inserting a key and searching for a given key; or, in different words, supporting or enabling the use of some information in association with the searchable means, the searchable means then being consultable to determine if the information has been previously used in association with the searchable means. This includes, but is not limited to, content addressable memory and hardware or software implementations of search trees, binary search trees, hashing, skip lists, radix search, tries and other equivalents known in the art. The term “searchable means” is not intended to be interpreted as a “means” clause as specified in 35 U.S.C. §112, ¶6.

A duplicate packet stream is a packet stream whose packets comprise some payload, each packet containing identifying information. By selecting packets from one or more cooperating duplicate packet streams a complete copy of the payload can be recovered, this allows a duplicate packet stream to experience delays or packet loss whilst still allowing the payload to be recovered.

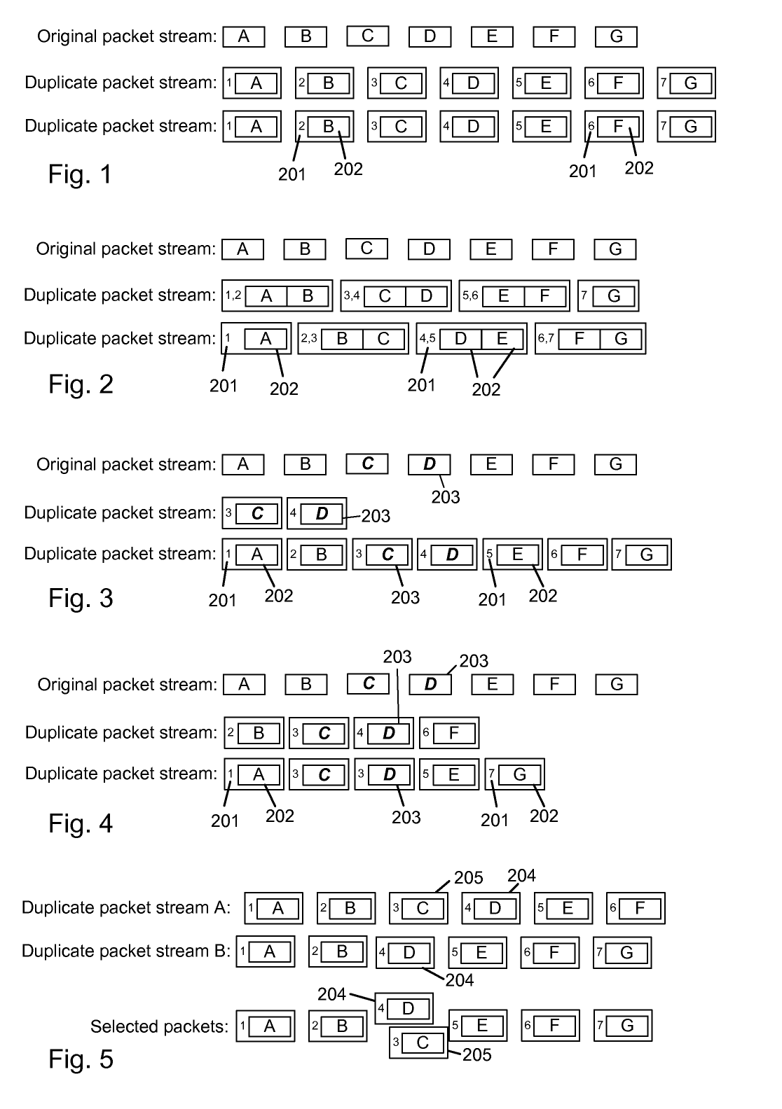

Example duplicate packet streams are illustrated in FIGS. 1,2,3 and 4. In FIG. 1 the payload is a packet stream and each packet in the payload packet stream is assigned a sequence number which corresponds to each packet's position. Two duplicate packet streams are constructed with each packet of a duplicate packet stream comprising a sequence number 201 corresponding to a packet from the original packet stream as identifying information and a copy of the relevant packet 202 from the original packet stream.

FIGS. 2, 3 and 4 show further examples of other possible configurations of duplicate packet streams using assigned sequence numbers as the identifying information. FIG. 2 shows duplicate packet streams with multiple packets and multiple sequence numbers contained within a single duplicate packet, the packets distributed differently depending on the specific duplicate packet stream. FIG. 3 shows duplicate packet streams where only critical packets 203 from the original packet stream are duplicated and FIG. 4 shows another configuration where again only critical packets 203 from the original packet stream are duplicated.

Duplicate packet streams may be configured in many ways and should not be interpreted to be limited to any particular form described. Methods and apparatus embodying principles of the invention are not limited to operating on duplicate packet streams as described or shown and a person having ordinary skill in the art will be able to devise many more packet arrangements to which principles of the invention can be applied.

In one possible application a transmitting network node or device creates a plurality of cooperating duplicate packet streams and transmits them, possibly over multiple physically distinct pathways, to a receiving device which selects packets in accordance with principles of the invention. When a packet has been selected the receiving device performs whatever other actions are necessary to recover the payload, this is dependent on the payload and is beyond the scope of this disclosure.

A method for selecting packets from a plurality of duplicate packet streams is described, the method embodying principles of the invention. The method operating on duplicate packet streams whose packets contain identifying information which enable the position of a portion of payload contained by a packet to be determined relative to the position of a portion of payload contained in another packet of a duplicate packet stream.

When a packet is received (the “received packet”) from one of a plurality of duplicate packet streams it is inspected to determine its identifying information (its “identifier”). Its identifier is compared to an identifier stored from a previously selected packet (the “previous identifier”) to determine the position of the portion of payload contained by the received packet (the “received portion”) relative to the position of the contained portion of payload of a previously selected packet (the “previous portion”). If there is no previous identifier the received packet is selected and its identifier is stored as the previous identifier.

If it is determined that the received portion is positioned after the previous portion then: the received packet is expected and it is selected; the identifier is compared to the previous identifier to determine if there are any portions of payload that were positioned after the previous portion but before the received portion, and if there are the identifiers of those packets containing those portions of payload are identified and inserted into a searchable means, and; the identifier of the received packet is stored as the previous identifier.

If it is determined that the received portion is the same as the previous portion then the packet is not expected and is discarded.

If it is determined that the received portion is positioned before the previous portion then the received packet is not expected, and a search is made in the searchable means for the identifier, if the search does not find a match then the packet is discarded. If the search does find a match then the packet, which has not been previously selected, is selected and the identifier deleted from the searchable means.

The searchable means employed by the described method allows unexpected unselected identifiers to be identified and selected, this yields a method which allows the selection of unselected packets as soon as they are made available for selection whilst avoiding delay and packet loss if packets are delayed or lost on only some of the available duplicate packet streams. Implementing a high speed searchable means, such as content addressable memory, allows the construction of apparatus embodying principles of the invention which develop high levels of performance suitable for use with performance critical applications.

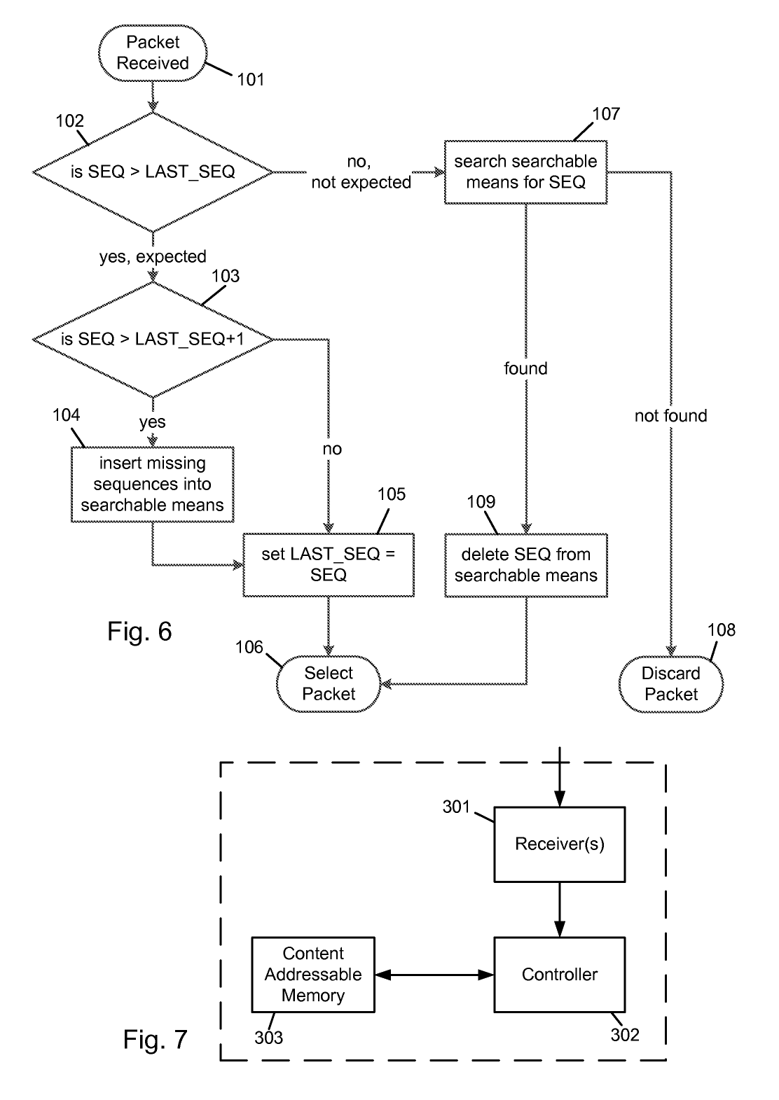

An example implementation of the previously described method is described and is illustrated by FIG. 6. The example operating on duplicate packet streams whose packets have identifying information comprising an assigned sequence number which is incremented by one for each subsequent packet. Examples of such duplicate packet streams are shown in FIG. 1, with sequence numbers 201 and corresponding packets 202 indicated, the examples carrying a packet from an original packet stream in each packet of the duplicate packet stream. The example implementation selects packets from a plurality of cooperating duplicate packet streams in such a way that a single copy of the original packet stream is selected and recoverable.

FIG. 5 illustrates the order in which the example implementation will select packets from the duplicate packet streams of FIG. 1 when duplicate packet stream A has incurred slightly more delay than duplicate packet stream B and when duplicate packet stream B has suffered the loss of packet 205. As we can see, packet 204 is selected before packet 205 and no additional delay is experienced with packets being selected as soon as they are selectable.

The example implementation in combination with cooperating duplicate packet streams of a type exemplified by FIG. 1 offers several advantages, amongst which is that packets will be selected in-order unless a packet is lost from a duplicate packet stream or a duplicate packet stream is being delivered out-of-order. A further advantage is that with careful hardware selection, such as the use of content addressable memory, the average delay and jitter characteristics of the communications may be improved over that of traditional non-duplicated links.

The packet is received 101 from a duplicate packet stream and inspected to determine its sequence number, SEQ. SEQ is compared 102 to the stored identifier of a previously selected packet, LAST_SEQ, to determine if the received portion was positioned before or after the previous portion. If SEQ>LAST_SEQ then the received portion was positioned after the previous portion and the packet is expected, otherwise the packet is not expected.

If the packet is expected then SEQ is compared 103 to LAST_SEQ to determine if there are any packets which were expected to be received before the received packet but after the previously selected packet. This is accomplished by testing if SEQ>LAST_SEQ+1, that is, if the sequence number of the packet is more than one greater than the sequence number LAST_SEQ.

If SEQ>LAST_SEQ+1 then there is at least one sequence number between SEQ and LAST_SEQ and indicates that we did expect to receive at least one packet before the received packet. The sequence numbers corresponding to these unreceived packets are then inserted 104 into the searchable means, the sequence numbers that are to be inserted are simply the sequence numbers that lie between SEQ and LAST_SEQ; the searchable means thus comprising a searchable set of sequence numbers. LAST_SEQ is then set equal to SEQ 105 and the received packet is selected 106.

Returning to the test 103, if SEQ is not greater than LAST_SEQ+1 then LAST_SEQ is set equal to SEQ 105 and the received packet is selected 106.

Returning to the test 102, if the test indicates that the packet is unexpected, that is if SEQ is not greater than LAST_SEQ, then the searchable means is searched 107 for SEQ. If SEQ is not found in the searchable means the packet is discarded 108. If however the search does find SEQ in the searchable means, then SEQ is deleted 109 from the searchable means and the packet is selected 106.

An optional step may be added between the first test 102 and the search 107, the step comprising testing if SEQ is equal to LAST_SEQ and discarding the packet if SEQ=LAST_SEQ, the search 107 being performed only if SEQ is not equal to LAST_SEQ. For some implementations of the searchable means this may improve performance.

An apparatus embodying principles of the invention is described, the apparatus illustrated as a high level block diagram in FIG. 7. The apparatus comprising: one or more receivers 301 for receiving duplicate packet stream packets; a controller 302 implementing the method described above, and; searchable means 303 in the form of content addressable memory operable by the controller.

The apparatus suitable for integration with, or use as a network node such as a router, switch, network interface controller, network interface card or other network device.

The one or more receivers 301 receive packets and pass them to the controller 302, the receivers may be comprised of network interface controllers adapted to receive data from a specific type of network, such as Ethernet, Token Ring, SONET/SDH, ATM, 802.11 or similar.

The controller 302 maintaining a variable containing identifying information from a previously selected packet and operating the searchable means 303 to perform search and insert operations. The controller 302 operating to select packets in accordance with the method described above.

Whilst the described apparatus uses a searchable means in the form of content addressable memory, this is only one option of many possible hardware or software implemented searchable means; apparatus implementations should not be construed as being limited to content addressable memory.

An alternative method is described, the method operating on duplicate packet streams whose packets each contain identifying information which can uniquely identify the portion of payload contained by the packet.

When a packet is received (the “received packet”) from one of the plurality of duplicate packet streams it is inspected to determine its identifying information (its “identifier”) and a search is made in a searchable means for the identifier. If the identifier is found the packet is selected and the identifier removed from the searchable means. If the identifier is not found the packet is discarded.

The searchable means can be populated by many methods including, for example, transmitting expected packet information as part of the payload and inserting the contained information into the searchable means when a packet is selected.

Although specific embodiments of the invention have been shown and described herein, it is to be understood that these embodiments are merely illustrative of the many possible specific arrangements that can be devised in application of the principles of the invention. Numerous and varied other arrangements can be devised by those of ordinary skill in the art without departing from the scope and spirit of the invention.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What I claim is:

1. A method for selecting packets from a plurality of packets received on a network node the method comprising:
(a) receiving a packet;
(b) determining identifying information for the received packet;
(c) determining a search key using the identifying information;
(c) searching a searchable means for the search key, and if the search key is found, selecting the received packet and removing the search key from the searchable means.

2. The method of claim 1 wherein the network node is a router, switch, network interface controller or network interface card.

3. The method of claim 1 wherein the searchable means comprises content addressable memory.

4. The method of claim 1 wherein the plurality of packets are comprised of frames, layer 3 packets, datagrams, protocol data units, service data units or segments.

5. A method for selecting data on a computer, the method comprising:
(a) determining identifying information associated with the data;
(b) comparing the identifying information with previously stored information to determine if the data is expected;
(c) if the data is expected:
(i) selecting the data;
(ii) identifying unselected data which is expected but which will no longer be expected due to the selection of the data;
(iii) making the identifying information associated with the identified unselected data locatable by a searchable means, and;
(iiii) updating the previously stored information with regard to the identifying information;
(d) if the data is not expected, searching a searchable means for the identifying information, and if the identifying information is located:
(i) selecting the data, and;
(ii) causing the identifying information to no longer be locatable by the searchable means.

6. The method of claim 5 wherein the searchable means comprises content addressable memory.

7. The method of claim 5 wherein the identifying information is a sequence number associated with each data.

8. A method for selecting packets received on a network node the method comprising:
(a) maintaining a last sequence number, the last sequence number being a sequence number associated with a previously selected packet;
(b) receiving a packet;
(c) retrieving a packet sequence number from the received packet;
(d) comparing the packet sequence number to the last sequence number;
(e) if the packet sequence number is greater than the last sequence number:
(i) selecting the received packet;
(ii) adding sequence numbers less than the packet sequence number and greater than the last sequence number to a searchable means, and;
(iii) replacing the last sequence number with the packet sequence number;
(f) if the packet sequence number is less than the last sequence number, searching the searchable means for the packet sequence number, and if the packet sequence number is found, selecting the received packet and removing the packet sequence number from the searchable means.

9. The method of claim 8 wherein the network node is a router, switch, network interface controller or network interface card.

10. The method of claim 8 wherein the network node is a general purpose computer.

11. The method of claim 8 wherein the searchable means comprises content addressable memory.

12. The method of claim 8 wherein the packets received on the network node are comprised of frames, layer 3 packets, datagrams, protocol data units, service data units or segments.

13. An apparatus for selecting packets from a plurality of duplicate packet streams, the apparatus comprising:
(a) a receiver operable to receive packets from at least one of the plurality of duplicate packet streams, each of said packets having a sequence number corresponding to its intended position in the packet stream;
(b) a controller being operable to maintain a searchable set of sequence numbers, each sequence number within the set corresponding to the intended position in the packet stream of a packet which is to be received, and;
(c) the controller being operable to cause a particular packet to be selected responsive to the particular packet having a sequence number contained within the searchable set of sequence numbers.

14. The apparatus of claim 13 wherein the searchable set of sequence numbers comprises a searchable means.

15. The apparatus of claim 13 wherein the searchable set of sequence numbers comprises content addressable memory.

16. The apparatus of claim 13 wherein the apparatus is part of a router or switch.

17. The method of claim 13 wherein the packets are frames, layer 3 packets, datagrams, protocol data units, service data units or segments.

18. The apparatus of claim 13 further comprising:
(d) the controller being operable to maintain information required to determine the next expected sequence number, the next expected sequence number corresponding to the position in the packet stream of a next packet to be received;
(e) the controller being operable to cause a particular packet to be selected responsive to the particular packet having a sequence number equal to the next expected sequence number, and;
(f) the controller being operable to cause a particular packet to be selected responsive to the particular packet having a sequence number greater than the next expected sequence number and to insert all sequence numbers equal to and greater than the next expected sequence number but less than the sequence number of the particular packet into the searchable set of sequence numbers.

19. The method of claim 18 wherein the packets are frames, layer 3 packets, datagrams, protocol data units, service data units or segments.

20. The apparatus of claim 18 wherein the apparatus is part of a router or switch.
